(19) United States
(12) Patent Application Publication
(10) Pub. No.: US 2013/0081129 A1
(43) Pub. Date: Mar. 28, 2013

(54) Outbound Connection Detection and Blocking at a Client Computer

(71) Applicant: Jarno NIEMELÄ, Espoo (FI)

(72) Inventor: Jarno NIEMELÄ, Espoo (FI)

(73) Assignee: F-Secure Corporation

(21) Appl. No.: 13/242,472

(22) Filed: Sep. 23, 2011

(51) Int. Cl. G06F 15/16; G06F 12/14

(52) U.S. Cl. 726/11; 726/22

(57) ABSTRACT

A method of detecting and blocking a malicious SSL connection at a client computer. The method includes identifying, at a network firewall level, an outbound SSL connection being set up at the client computer; detecting an SSL certificate associated with the SSL connection; sending a request to a central server for reputation information on the SSL certificate; at the central server, determining reputation information in dependence upon the SSL certificate; providing said reputation information from the central server to the client computer; and using the reputation information at the client computer to determine whether or not to block the connection.

### TECHNICAL FIELD

The present invention relates to a method of detecting and blocking an outbound connection at a client computer. In particular the present invention relates to a method of detecting and blocking a malicious SSL connection at a client computer.

### BACKGROUND

The term “malware” is short for malicious software and is used to refer to any software designed to infiltrate or damage a computer system without the owner's informed consent. Malware can include viruses, worms, trojan horses, rootkits, adware, spyware and any other malicious and unwanted software. Many computer devices, such as desktop personal computers (PCs), laptops, personal data assistants (PDAs) and mobile phones can be at risk from malware.

Detecting malware is often challenging, as malware may be designed to be difficult to detect, often employing technologies that deliberately hide the presence of malware on a system. Malware often uses backdoor components (“backdoors”) to communicate with a central command and control (C&C) server from which it can receive instructions. Backdoors used by attackers tend to contain binary code that is unique for each instance, or at least the binary code has a very low prevalence. These backdoors can therefore be difficult to detect. One method of detecting backdoor components (and subsequently the associated malware) is to detect for low prevalence binary code. However, binary code with low prevalence can also be found in non-malicious software and software components, for example a locally compiled net executable, and so the detection of this alone is not sufficient to conclude that a backdoor has been found.

Most backdoors use reverse HTTP to communicate with a C&C server, in which the backdoor client polls the C&C server for instructions. The HTTP requests sent from backdoors tend to pass through most firewalls because there are so many applications that submit HTTP requests that it would not be conducive for the firewalls to prompt for all of them. One way to detect reverse HTTP backdoors is to inspect the HTTP traffic, but malware authors have become aware of this and so now produce backdoors that use Secure Sockets Layer (SSL) tunnelling for C&C traffic. HTTPS tunnelling in this way protect backdoor traffic by encrypting it and therefore allows the communication between the backdoor and the C&C server to pass through most firewalls undetected.

### SUMMARY

It is an object of the present invention to provide a method of detecting and blocking malicious SSL connections, for example SSL connections that are created by backdoors in order to use SSL tunnelling for C&C traffic. This object is achieved by using reputation information for the SSL certificates exchanged when the SSL connection is initiated.

According to a first aspect of the invention, there is provided a method of detecting and blocking a malicious SSL connection at a client computer. The method comprises identifying, at a network firewall level, an outbound SSL connection being set up at the client computer, detecting an SSL certificate associated with the SSL connection and sending a request to a central server for reputation information on the SSL certificate, at the central server, determining reputation information in dependence upon the SSL certificate, providing said reputation information from the central server to the client computer; and using the reputation information at the client computer to determine whether or not to block the connection.

A hook may be used to monitor outbound communications from the client computer in order to identify the outbound SSL connection being set up.

The SSL certificate may be detected by intercepting it from the plaintext portion of an initial handshake carried out to set up the SSL connection.

The request sent to the central server may include the SSL certificate, or a hash thereof.

The step of determining the reputation information at the server may comprise performing on-the-fly analysis of the SSL certificate, or hash thereof, and/or searching a database of known SSL certificate reputation information

The reputation information may comprise a rating assigned to the SSL certificate.

The step of using the reputation information at the client computer to determine whether or not to block the connection may comprise comparing the reputation information with security level settings on the client computer.

According to a second aspect of the invention, there is provided a method of detecting and blocking a malicious SSL connection at a client computer. The method comprises identifying, at a network firewall level, an SSL connection that is set up without an SSL certificate being exchanged, and blocking the identified SSL connection.

According to a third aspect of the invention, there is provided a method of protecting a client computer from malware, which malware attempts to establish an SSL connection with an external server. The method comprises carrying out the steps of any of the previous aspects of the invention, and, for any connections that are blocked, flagging up the application that initiated the SSL connection as malware.

The method may further comprise placing the flagged application in quarantine.

According to a fourth aspect of the invention, there is provided a client computer comprising a hooking unit for monitoring outbound communications from the client computer and detecting SSL certificates from handshakes for initiating SSL connections, a security settings handler for sending reputation information requests to a reputation server and receiving reputation information from said reputation server, and for comparison of the received reputation information with security settings on the client computer, and a connection blocking unit for blocking any SSL connections where the corresponding SSL certificates' reputations do not pass the requirements of the security settings.

The client computer may be a personal computer, a mobile device, or any other internet-connected device.

According to a fifth aspect of the invention, there is provided a reputation server or server cluster, for serving a multiplicity of client computers. The central server or server cluster comprises a database of SSL certificate reputations, a reputation determination unit for searching the database to find the SSL certificate reputations that correspond with reputation information requests being received from one or more client computers, and a transmitter for sending the reputation information back to the respective client computers, said reputation information comprising the SSL certificate reputations for the SSL certificates indicated in the received information requests.

The reputation determination unit may also be used for performing on-the-fly analysis of the SSL certificates indicated in the received information requests.

According to a sixth aspect of the invention, there is provided a non-transitory computer readable medium storing a computer program which, when run on a computer device, causes the computer device to behave as a client computer according to the fourth aspect of the invention.

According to a seventh aspect of the invention, there is provided a non-transitory computer readable medium storing a computer program which, when run on a server, causes the server to behave as a reputation server according to the fifth aspect of the invention.

According to an eighth aspect of the invention, there is provided a computer program product comprising a computer-readable medium bearing computer program code embodied therein for use with a computer. The computer program code comprises code for identifying, at a network firewall level, an outbound SSL connection being set up at the client computer, code for detecting an SSL certificate associated with the SSL connection, code for sending a request to a central server for reputation information on the SSL certificate, and code for using reputation information received at the client computer to determine whether or not to block the connection.

### BRIEF DESCRIPTION OF THE DRAWINGS

FIG. 1 is a representation of the first stages of setting up an SSL connection;

FIG. 2 is a flow diagram that illustrates a method of controlling SSL connections at a client computer according to an embodiment of the present invention;

FIG. 3 is a flow diagram showing the steps of a method according to an embodiment of the present invention; and

FIG. 4 is a schematic representation of a computer system according to an embodiment of the present invention.

### DETAILED DESCRIPTION

As previously discussed malware authors have become aware of the current methods of inspecting HTTP traffic in order to detect reverse HTTP backdoors and so now produce backdoors that use SSL tunnelling for C&C traffic.

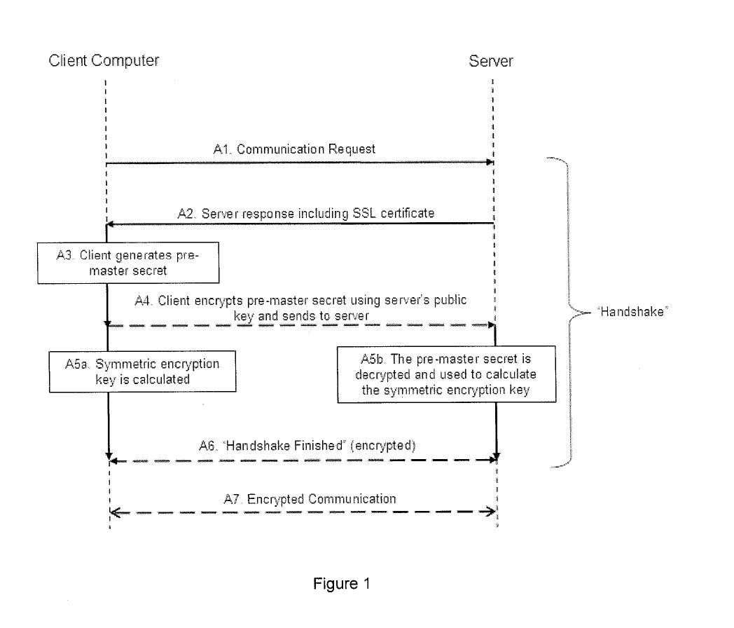

FIG. 1 is a representation of the first stages of setting up an SSL connection (the “handshake”) between a client computer and a server. The steps are as follows:
A1. The client sends a communication request to the server.
A2. The server responds and includes its SSL certificate.
A3. The client generates a pre-master secret, which is a random number that can be used to generate an encryption key.
A4. The client then encrypts the pre-master encryption key and sends it to the server.
A5. a) At the client, a symmetric encryption key is calculated using the pre-master secret.
   b) At the server, the pre-master secret is decrypted and used to calculate the same symmetric encryption key.
A6. Encrypted messages indicating that the handshake is finished are exchanged between the server and the client computer.
A7. With the SLL connection complete, encrypted communication between the server and the client computer can begin.

The solid arrows at steps A1 and A2 represent communications between the client computer and the C&C server which are sent in plaintext (i.e. they are not encrypted). The initial steps of the handshake are carried out in plaintext because an encrypted session cannot be started until the certificate has been exchanged, and the encryption key that is to be used has been generated. Only once the handshake is complete will a component able to decipher any encrypted data that it receives.

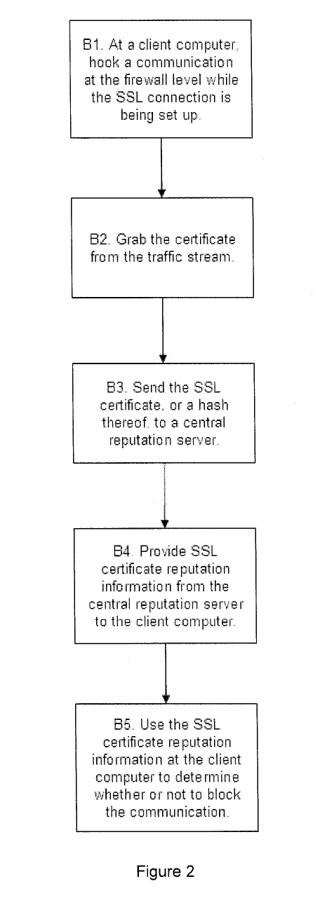

A method will now be disclosed that uses backdoor traffic that is sent using HTTPS tunnelling to control outbound communications from a client computer and identify malware that is running on the machine. The method involves using the reputation of the SSL certificates that are exchanged when an SSL is being set up to identify suspicious connections, e.g. connections that may be used for communication between malware and a C&C server. FIG. 2 is a flow diagram that illustrates a method of detecting and blocking malicious SSL connections at a client computer. The steps of the method are:
B1. At a client computer, hook a communication at the network firewall level while the SSL connection is being set up.
B2. Detect the SSL certificate from the traffic stream.
B3. Send the SSL certificate, or a hash thereof, to a central reputation server.
B4. Provide SSL certificate reputation information from the central reputation server to the client computer.
B5. Use the SSL certificate reputation information at the client computer to determine whether or not to block the connection.

Hooking is a technique used in computer programming to intercept communications. In step B1 the communication is hooked at the network firewall level of the client computer. The initial plaintext exchange within the SSL connection handshake allows the hook to detect, i.e. “sniff”, the certificate from the traffic stream in Step B2.

The method is typically carried out by security software that is installed on the client computer and that is provided by a security software provider. In an example, the central reputation server is a web server or web server cluster run by the security software provider, and comprises a database on which is stored known certificate reputation information. The central reputation server can provide certificate reputation information for certificates that are known by retrieving the known reputation from the database, and can also provide certificate reputation information for certificates that are unknown by performing on-the-fly analysis (for example, by automatic data-mining) of the certificate or certificate hash received from a client computer. Once the analysis has been performed on the unknown certificate, it can be entered, along with its newly determined reputation information, into the database of known certificate reputation information for future reference. The database can therefore be populated both manually, i.e. by an analyst who seeks out unknown certificates to analyse and enter in the database, and automatically, i.e. by analysis performed on-the-fly on unknown certificates received from client computers running the security software.

In an embodiment of the invention, the certificate reputation information comprises a rating for each certificate. The analysis required to determine the reputation of an SSL certificate can be carried out in a number of different ways, and it is expected that a combination of one or more these will be used not only when creating entries in the database, but also when the on-the-fly analysis is performed. Some examples of different types of analysis will now be described. The simplest way to determine a reputation for an SSL certificate is to have a human analyst analyse the binary for known malicious backdoors and add the certificate that is sent from the client computer to the reputation database and assign it a bad rating. The analyst may also use the known backdoor within a controlled environment, such as a sandbox, to obtain the C&C server's SSL certificate. The C&C server's certificate can then also be added to the reputation database with a bad rating.

Another method is to use SSL certificate properties. For example, all SSL certificates that are not issued by a trusted Certificate Authority (CA), e.g. VeriSign™ or GlobalSign™, are given poor ratings. Similarly, certificates that are not signed or that are not associated with the domain name where the server is located are also given poor ratings.

A further method is to perform checks on the company name and address information contained within the certificate. Certificates that are used to initiate SSL connections that allow malware to communicate with C&C servers typically have no structure in the company name and address fields, with only random text being entered. A certificate found to have random text entered in the company name and address fields in this way will be assigned a bad rating.

The final example is to use an SSL certificate's prevalence to determine its reputation. Legitimately used SSL certificates usually have very high prevalence, and so a certificate with no prevalence information can be seen as being suspicious and so is given a poor rating.

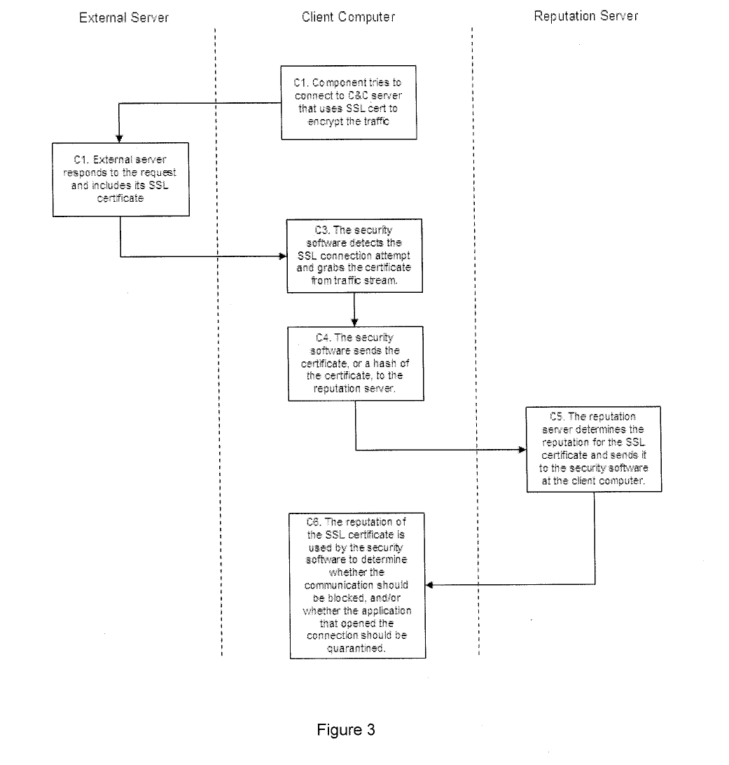

An example of the method in use will now be described. In this example a component on the client computer is attempting to communicate with an external server using SSL encryption. The component on the client computer may be a backdoor component being used by malware, and the external server may be a C&C server. The client computer is provided with security software that runs at the network firewall level and which monitors the inbound and outbound communication traffic. FIG. 3 is a flow diagram showing the steps of the method according to an embodiment of the present invention. The steps are as follows:
C1. A component on the client computer tries to connect to an external server that uses an SSL certificate to encrypt the traffic.
C2. The external server responds to the request and includes its SSL certificate.
C3. The security software detects the SSL connection attempt at the network firewall level and sniffs the certificate from traffic stream.
C4. The security software sends the certificate, or a hash of the certificate, to the reputation server.
C5. The reputation server determines the reputation information for the SSL certificate and sends it to the security software at the client computer.
C6. The reputation information for the SSL certificate is used by the security software to determine whether the connection should be blocked.

In step C6, the rating in the SSL certificate reputation information can be checked against the security level settings within the security software. If the reputation information passes the requirements of the security level settings, then communication over the SSL connection with the external server is allowed to continue. If, however, the reputation information does not pass the requirements of the security level settings, then it is deduced that a backdoor component has been detected and the connection with the external server is blocked.

An SSL connection that is established using a certificate with a particularly bad rating (for example a certificate that is known to be used by malware), may automatically be blocked, and the application that initialised the connection quarantined immediately. An SSL connection that is established using a certificate with a low rating (for example a certificate that is previously unknown and with low prevalence) may cause the security software to block the connection and may further send details of the corresponding application to the provider of the security software for further analysis.

In order to make malware networks more resistant to discovery and counter-measures, malware authors often makes use of a distributed command and control in the form of a fast flux network. In a fast flux network, there is no single C&C server. Instead there is an ever changing network of C&C servers and/or proxies (and, therefore, IP addresses) that can perform the same role as a single C&C server. This can cause problems when trying to detect the command and control for malware using standard techniques (for example IP-based access control lists). However, it is highly likely that each of the C&C servers within a fast flux network will share the same SSL certificate, and so the method described above will still be effective in the detection of SSL connections between a backdoor component on a client computer and a fast flux C&C network.

The example above describes the method when only the external server uses an SSL certificate to establish the connection. In an alternative example, the client computer also uses an SSL certificate for authenticating with the external server. It is highly likely that the SSL certificate used by a malware backdoor component on one client computer will be used by all instances of the same backdoor component installed on other client computers that are generated from the same source, for example from the same malware infection server. Once an SSL certificate is known to be used by malware backdoors on client computers to communicate with C&C servers, it can be entered into the database of known SSL certificate reputation information. Therefore, if said known SSL certificate is detected when monitoring the outbound communication traffic at a client computer, it can be deduced that a malware backdoor component has been detected, and the connection can be blocked. The steps of the method in this example are the same as for the previous example, except that the security software detects (or “sniffs”) the outbound SSL certificate from the traffic stream, rather than the inbound SSL certificate from the external server. In a further alternative, the security software is able to detect both outbound and inbound SSL certificates.

Of course, it is expected that sooner or later malware authors will become aware that the security software monitors the outbound and inbound traffic and detects the SSL certificates exchanged during handshakes in order to detect backdoor components and block malware connections. An obvious alternative that the malware author can use to evade the security software's detection method is to build the C&C server's SSL certificate into malware binary. By doing this, the backdoor component will be able to establish a secure connection with the C&C server whilst avoiding the plaintext part of the handshake when the SSL certificate is exchanged. However, this approach is very unusual and would not be used by “clean” (non-malware) applications, making the approach itself easily detectable. The security software can, therefore, be programmed to monitor the traffic stream and detect any secure connections that are set up without an SSL certificate being exchanged. If such a secure connection is detected, then it is blocked.

The examples presented above describe the security software blocking the connection, but it will be understood that further actions may be taken, the further actions being typical actions carried out by security software when malware is detected. For example, the application that opened the connection may be reported as malware and/or quarantined, the user of the client computer may be alerted to the detection, and information regarding the detection and/or details of the application that initiated the connection may be sent to the provider of the security software.

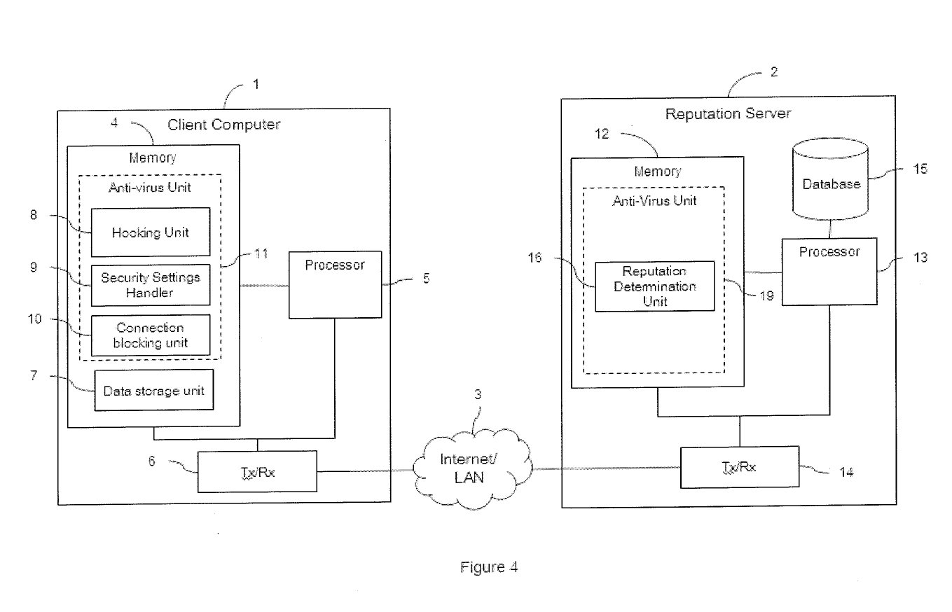

FIG. 4 is a schematic representation of a computer system according to an embodiment of the present invention. The computer system comprises at least one client computer 1 connected to a reputation server 2 over a network 3 such as the Internet or a LAN. The client computer 1 can be implemented as a combination of computer hardware and software. The client computer 1 comprises a memory 4, a processor 5 and a transceiver 6. The memory 4 stores the various programs/executable files that are implemented by the processor 5.

The memory 4 also provides a data storage unit 7 for any required data such as SSL certificate reputation data, white lists, black lists etc. The programs/executable files stored in the memory 4, and implemented by the processor 5, include a hooking unit 8, a security settings handler 9 and connection blocking unit 10, all of which can be sub-units of an anti-virus unit 11. The transceiver 6 is used to communicate with the central anti-virus server 2 over the network 3.

The reputation server 2 is typically operated by the provider of the anti-virus unit 11 that is run on the computer 1. Alternatively, the reputation server 2 may be that of a network administrator or supervisor, the computer 1 being part of the network for which the supervisor is responsible. The reputation server 2 can be implemented as a combination of computer hardware and software. The reputation server 2 comprises a memory 12, a processor 13, a transceiver 14 and a database 15. The memory 12 stores the various programs/executable files that are implemented by the processor 13. The programs/executable files stored in the memory 12, and implemented by the processor 13, include a reputation determination unit 16, which can be a sub-unit of an anti-virus unit 19. The programs/units implemented at the reputation server 2 are capable of interfacing and co-operating with the programs implemented at the computer system 1. The transceiver 14 is used to communicate with the computer system 1 over the network 3. The database 15 stores the SSL certificate reputation data, and may also store other relevant data such as malware definition data, heuristic analysis rules, white lists, black lists etc.

It will be appreciated by the person of skill in the art that various modifications may be made to the above described embodiments without departing from the scope of the present invention.

1. A method of detecting and blocking a malicious SSL connection at a client computer, the method comprising:
identifying, at a network firewall level, an outbound SSL connection being set up at the client computer;
detecting an SSL certificate associated with the SSL connection;
sending a request to a central server for reputation information on the SSL certificate;
at the central server, determining reputation information in dependence upon the SSL certificate;
providing said reputation information from the central server to the client computer; and
using the reputation information at the client computer to determine whether or not to block the connection.

2. A method as claimed in claim 1, wherein a hook is used to monitor outbound communications from the client computer in order to identify the outbound SSL connection being set up.

3. A method as claimed in claim 1, wherein the SSL certificate is detected by intercepting it from the plaintext portion of an initial handshake carried out to set up the SSL connection.

4. A method as claimed in claim 1, wherein the request sent to the central server includes the SSL certificate, or a hash thereof.

5. A method as claimed in claim 4, wherein determining the reputation information at the server comprises performing on-the-fly analysis of the SSL certificate, or hash thereof.

6. A method as claimed in claim 1, wherein determining the reputation information at the server comprises searching a database of known SSL certificate reputation information

7. A method as claimed claim 1, wherein the reputation information comprises a rating assigned to the SSL certificate.

8. A method as claimed claim 1, wherein the step of using the reputation information at the client computer to determine whether or not to block the connection comprises comparing the reputation information with security level settings on the client computer.

9. A method of detecting and blocking a malicious SSL connection at a client computer, the method comprising:
identifying, at a network firewall level, an SSL connection that is set up without an SSL certificate being exchanged; and
blocking the identified SSL connection.

10. A method of protecting a client computer from malware, which malware attempts to establish an SSL connection with an external server, the method comprising:
carrying out the steps of claim 1; and
for any connections that are blocked, flagging up the application that initiated the SSL connection as malware.

11. A method as claimed in claim 10, wherein the method further comprises placing the flagged application in quarantine.

12. A client computer comprising:
a hooking unit for monitoring outbound communications from the client computer and detecting SSL certificates from handshakes for initiating SSL connections;
a security settings handler for sending reputation information requests to a reputation server and receiving reputation information from said reputation server, and for comparison of the received reputation information with security settings on the client computer; and
a connection blocking unit for blocking any SSL connections where the corresponding SSL certificates' reputations do not pass the requirements of the security settings.

13. A client computer as claimed in claim 12, wherein the client computer is a personal computer, a mobile device, or any other internet-connected device.

14. A reputation server or server cluster, for serving a multiplicity of client computers, the central server or server cluster comprising:
a database of SSL certificate reputations;
a reputation determination unit for searching the database to find the SSL certificate reputations that correspond with reputation information requests being received from one or more client computers; and
a transmitter for sending the reputation information back to the respective client computers, said reputation information comprising the SSL certificate reputations for the SSL certificates indicated in the received information requests.

15. A reputation server or server cluster as claimed in claim 14, wherein the reputation determination unit is also used for performing on-the-fly analysis of the SSL certificates indicated in the received information requests.

16. A non-transitory computer readable medium storing a computer program which, when run on a computer device, causes the computer device to behave as a client computer according to claim 12.

17. A non-transitory computer readable medium storing a computer program which, when run on a server, causes the server to behave as a reputation server according to claim 14.

18. A computer program product comprising a computer-readable medium bearing computer program code for use with a computer, the computer program code comprising:
code for identifying, at a network firewall level, an outbound SSL connection being set up at the client computer;
code for detecting an SSL certificate associated with the SSL connection;
code for sending a request to a central server for reputation information on the SSL certificate; and
code for using reputation information received at the client computer to determine whether or not to block the connection.
